(19) United States
(12) Patent Application Publication
(10) Pub. No.: US 2017/0308860 A1
(43) Pub. Date: Oct. 26, 2017

(54) COMPUTER-IMPLEMENTED SYSTEM AND METHODS FOR MODULATING EMPLOYMENT COMPENSATION

(71) Applicant: Dwayne Lloyd Samuel, Brooklyn, NY (US)

(72) Inventor: Dwayne Lloyd Samuel, Brooklyn, NY (US)

(21) Appl. No.: 15/193,886

(22) Filed: Jun. 27, 2016

Related U.S. Application Data
(60) Provisional application No. 62/324,931, filed on Apr. 20, 2016.

(51) Int. Cl. G06Q 10/10; G06Q 50/20

(52) U.S. Cl. CPC G06Q 10/105; G06Q 50/2057

(57) ABSTRACT

A computer-implemented system and method for modulating compensation of a client based on activities completed with a user device of the client is provided. In some embodiments the method may include the steps of: establishing communication between a server and a user device of a client, in which the client is associated with a compensation level in a database accessible to the server; distributing an activity from the database to the user device of the client; recording client input through the user device; comparing, via a computing device processor, the client input to a completion metric which is associated with the activity in the database; determining, via a computing device processor, if the activity has been completed by the client; and modulating the compensation level of the client in the database once the activity has been completed.

### CROSS REFERENCE TO RELATED APPLICATIONS

This application claims priority to and the benefit of the filing date of U.S. Provisional Application No. 62/324,931, filed on Apr. 20, 2016, entitled “SYSTEM AND METHOD FOR ONGOING TRAINING AND TEACHING BUSINESS METHODS AND SKILLS, ENSURING MASTERY WITH TESTING, TRACKING OF TRAINING COMPLETION AND SCORING AND ENSURING CONTINUOUS AND ONGOING TRAINING BY WAY OF REAL TIME USER INCENTIVIZATION”, which is hereby incorporated by reference in its entirety.

### FIELD OF THE INVENTION

This patent specification relates to the field of modulating employment compensation. More specifically, this patent specification relates to systems and methods that are configured to provide adaptive employment compensation to a user.

### BACKGROUND

Employment of an individual may be loosely defined as the trading of work done by the employee for compensation provided by an employer. Employers and professions in general may require an individual to complete training in order to become an employee or to become eligible to perform the work in a desired profession. Furthermore, employers and professions may require continuing training by the employee or current professional in order to maintain eligible status as an employee or professional. However, proof of this training can become hard to produce and authenticate. Typically, once an individual has completed training, they are required to present a certificate or other evidence showing that they have completed the training to an employer or professional review board for verification. Unfortunately, some individuals that may not have actually completed the training may present fraudulent evidence of training completion. Additionally, other individuals that have completed the training may be forced to wait for their training to be verified. This can result in the performance of work by under qualified individuals or conversely, prevent qualified individuals from being eligible to perform work that they are qualified for.

Therefore, a need exists for novel computer-implemented systems and methods for modulating employment compensation. A further need exists for novel computer-implemented systems and methods that are configured to modulate employment compensation based on training completed by an individual. Finally, a need exists for novel computer-implemented systems and methods that are configured to dynamically verify training completion to enable and/or modulate the employment compensation of an individual.

### BRIEF SUMMARY OF THE INVENTION

According to one embodiment consistent with the principles of the invention, a computer-implemented system and method for modulating compensation of a client based on activities completed with a user device of the client is provided. In some embodiments, the method may be used to enable the communication of information between the user devices of one or more users to modulate the compensation paid by an employer to a client based on one or more activities completed by the client using their respective user device. In further embodiments the method may include the steps of: establishing communication between a server and a user device of a client, in which the client is associated with a compensation level in a database accessible to the server; distributing an activity from the database to the user device of the client; recording client input through the user device; comparing, via a computing device processor, the client input to a completion metric which is associated with the activity in the database; determining, via a computing device processor, if the activity has been completed by the client; and modulating the compensation level of the client in the database once the activity has been completed.

According to another embodiment consistent with the principles of the invention, another computer-implemented method for modulating compensation based on activities completed with a user device of the client is provided. In some embodiments, the method may enable the communication of information between the user devices of one or more users to enable a client to receive compensation from an employer upon completion of one or more activities by the client using their respective user device. In further embodiments the method may include the steps of: establishing communication between a server and a user device of a client, wherein the client is associated with a compensation level in a database; associating a compensated employment position with a required activity in the database; distributing the required activity from the server to the user device of the client; recording client input through the user device; comparing, via a computing device processor, the client input to a completion metric which is associated with the required activity in the database; determining, via a computing device processor, if the required activity has been completed by the client; modulating the compensation level of the client in the database once the required activity has been completed; and designating the client as able to perform the compensated employment position once the required activity has been completed.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a system for modulating employment compensation according to various embodiments described herein.

FIG. 2 illustrates a block diagram showing an example of a server which may be used by the system as described in various embodiments herein.

FIG. 3 shows a block diagram illustrating an example of a user device which may be used by the system as described in various embodiments herein.

FIG. 4 depicts a block diagram illustrating some applications of a system for modulating employment compensation which may function as software rules engines according to various embodiments described herein.

FIG. 5 illustrates a block diagram illustrating an example of a compensation database of a system for modulating employment compensation according to various embodiments described herein.

FIG. 6 shows a block diagram of an example of a computer-implemented method for modulating compensation based on activities completed with a user device according to various embodiments described herein.

FIG. 7 depicts a block diagram of another example of a computer-implemented method for modulating compensation based on activities completed with a user device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the term “computer” refers to a machine, apparatus, or device that is capable of accepting and performing logic operations from software code. The term “application”, “software”, “software code” or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “electronic device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “user device” or sometimes “electronic device” or just “device” as used herein is a type of computer or computing device generally operated by a person or user of the system. In some embodiments, a user device is a smartphone or computer configured to receive and transmit data to a server or other electronic device which may be operated locally or in the cloud. Non-limiting examples of user devices include: personal computers (PCs), workstations, laptops, tablet PCs including the iPad, cell phones including iOS phones made by Apple Inc., Android OS phones, Microsoft OS phones, Blackberry phones, or generally any electronic device capable of running computer software and displaying information to a user. Certain types of user devices which are portable and easily carried by a person from one location to another may sometimes be referred to as a “mobile device” or “portable device”. Some non-limiting examples of mobile devices include: cell phones, smartphones, tablet computers, laptop computers, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as user devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, or a voice-over-IP (VoW) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a user device through the internet (i.e., the database is in the cloud) or alternatively in some embodiments the database may be stored on the user device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer-implemented systems and methods for modulating employment compensation are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

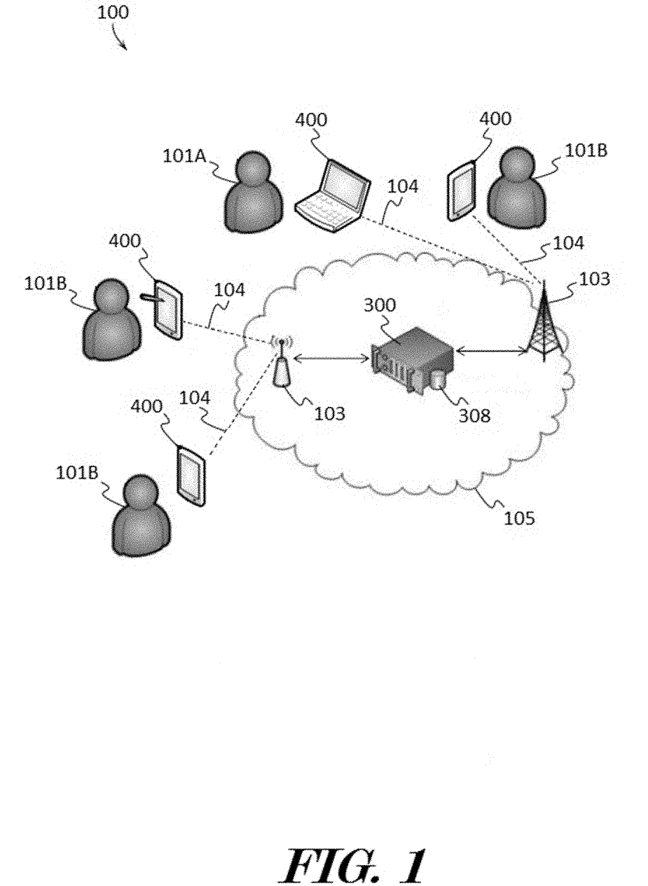

The present invention will now be described by example and through referencing the appended figures representing preferred and alternative embodiments. As perhaps best shown by FIG. 1, an illustrative example of some of the physical components which may comprise a system for modulating employment compensation (“the system”) 100 according to some embodiments is presented. The system 100 is configured to facilitate the transfer of data and information between one or more access points 103, user devices 400, and servers 300 over a data network 105. A data store 308 accessible by the server 300 may contain one or more databases. The data may comprise any information pertinent to one or more users 101 input into the system 100 including information on or describing one or more users 101, information requested by one or more users 101, information supplied by one or more users 101, and any other information which a user 101 may be provided such as for training and educational purposes.

In this example, the system 100 comprises at least one user device 400 (but preferably more than two user devices 400) configured to be operated by one or more users 101. User devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, user devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one user device 400 and/or server 300 programmed to perform one or more of the steps described herein. In some embodiments, more than one user device 400 and/or server 300 may be used, with each being programmed to carry out one or more steps of a method or process described herein.

In some embodiments, the system 100 may be configured to facilitate the communication of information between one or more users 101, through their respective user devices 400, and servers 300 of the system 100. Users of the system 100 may include one or more employers 101A and one or more clients 101B that may be individuals which are in or desire to be in an employment relationship with an employer 101A. An employment relationship may enable a client 101B to perform activities for the employer 101A and the employer 101A to provide compensation to the client 101B in exchange for those activities. In some embodiments, the system 100 may enable the communication of information between the user devices 400 of one or more users 101 to modulate the compensation paid by an employer 101A to a client 101B based on one or more activities completed by the client 101B using their respective user device 400. In further embodiments, the system 100 may enable the communication of information between the user devices 400 of one or more users 101 to enable a client 101B to receive compensation from an employer 101A upon completion of one or more activities by the client 101B using their respective user device 400.

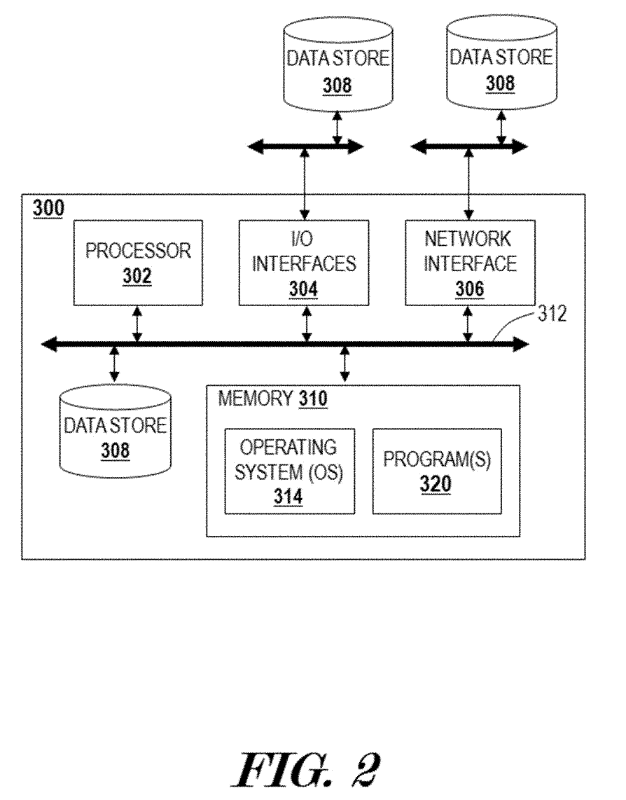

Referring now to FIG. 2, in an exemplary embodiment, a block diagram illustrates a server 300 of which one or more may be used in the system 100 or standalone. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 320 may be configured to implement the various processes, algorithms, methods, techniques, etc. described herein.

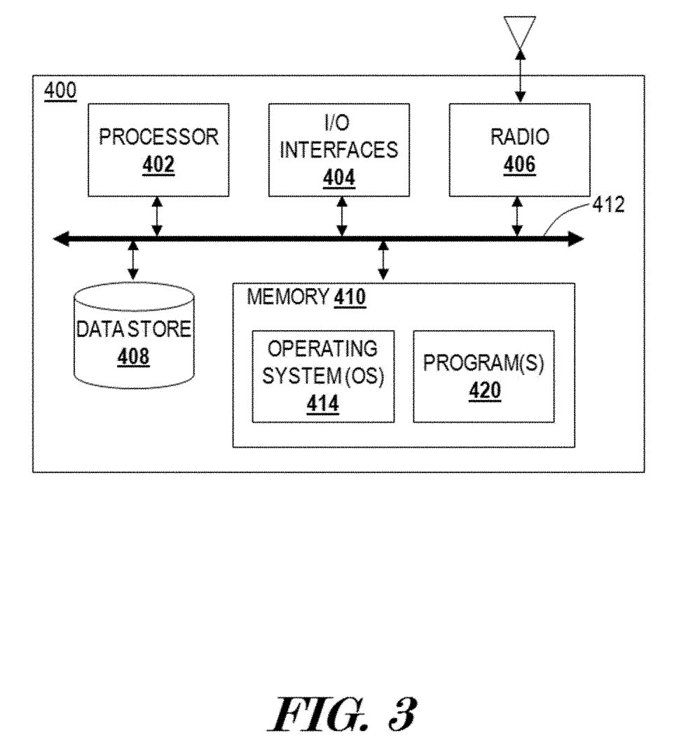

Referring to FIG. 3, in an exemplary embodiment, a block diagram illustrates a user device 400 of which one or more may be used in the system 100 or the like. The user device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the user device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the user device 400, a semiconductor-based microprocessor (in the form of a microchip or chip set), or generally any device for executing software instructions. When the user device 400 is in operation, the processor 402 is configured to execute software stored within the memory 410, to communicate data to and from the memory 410, and to generally control operations of the user device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display device such as a liquid crystal display (LCD), touch screen, and the like. The I/O interfaces 404 can also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the user device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, Microsoft Windows 10, iOS (available from Apple, Inc.), webOS (available from Hewlett Packard), Blackberry OS (Available from Research in Motion), and the like. The programs 420 may include various applications, add-ons, etc. configured to provide end user functionality with the user device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network 105 to manipulate information of the system 100.

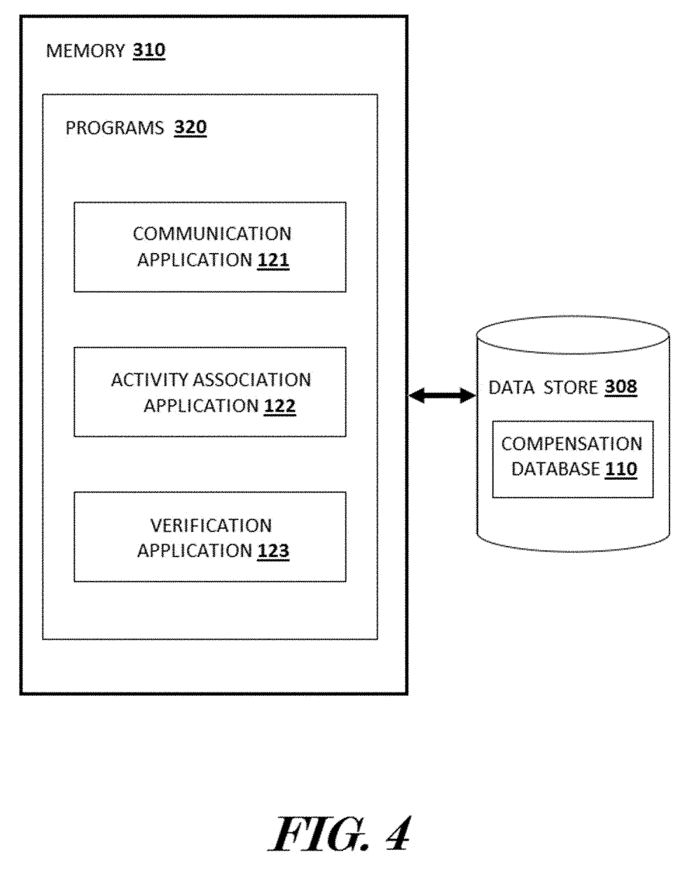

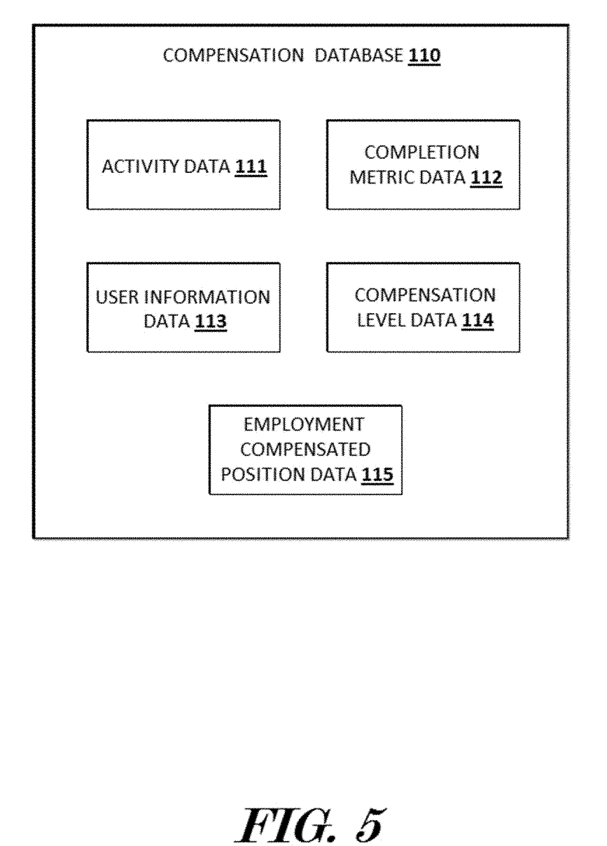

Referring now to FIG. 4 and FIG. 5., a block diagram showing some software rules engines which may be found in a system 100 (FIG. 1) and which may optionally be configured to run on a server 300 (FIGS. 1 and 2) and an example of a compensation database 110 according to various embodiments described herein are illustrated, respectively. In some embodiments, one or more servers 300 may be configured to run one or more software rules engines or programs such as a communication application 121, association application 122, and/or verification application 123. In this embodiment, the engines 121, 122, 123, are configured to run on at least one server 300. The server 300 may be in electronic communication with a data store 308 comprising a database, such as a compensation database 110. The engines 121, 122, 123, may read, write, or otherwise access data in one or more databases of the data store 308. Additionally, data may be sent and received to and from one or more user devices 400 (FIGS. 1 and 3) which may be in wired and/or wireless electronic communication with a server 300 through a network 105. In other embodiments, a communication application 121, association application 122, and/or verification application 123 may be configured to run on a user device 400 and/or server 300 with data transferred to and from one or more servers 300 in communication with a data store 308 through a network 105. In still further embodiments, a server 300 or a user device 400 may be configured to run a communication application 121, association application 122, and/or verification application 123.

In some embodiments, the system 100 may comprise a database, such as a compensation database 110, optionally stored on a data store 308 accessible to a communication application 121, association application 122, and/or verification application 123. In further embodiments, a completion database 110 may be stored on a data store 408 of a user device 400. A compensation database 110 may comprise any data and information pertinent to one or more users 101 input into the system 100. This data may include user information 113 which may comprise information on or describing one or more employers 101A. For example, user information 113 may include employer 101A information such as address or contact information, financial and financial account information, trade associations or organizations that the employer participates in, licensing or other government regulation compliance information, and/or any other information which may describe an employer 101A. User information 113 may also include information on or describing one or more clients 101B. For example, user information 113 may include client 101B information such as address or contact information, financial and financial account information, trade associations or organizations that the client participates in, education or training that the client has received or has not received, licensing or other government regulation compliance information, and/or any other information which may describe a client 101B.

The compensation database 110 may also include activity data 111 describing one or more activities. Activities may generally include tasks which may be completed by a client 101B on a user device 400 or which may be input into a user device 400. In some embodiments, an activity may include tasks such as participating or receiving training information, such as videos or audio files, displaying a video file on a display screen I/O interface 404 of the user device 400 of the client 101B, outputting an audio file through a speaker I/O interface of the user device 400 of the client 101B, displaying one or more questions on a display screen I/O interface 404 of the user device 400 of the client 101B, completing quizzes, tests, or other assessments, entering information, such as answers, responses, gestures, audio information, video information, and the like into, through or with a user device 400 of the client 1010B. For example, an activity may include completing a training module which involves watching a training video and answering questions about material presented in the video. The answers to the questions may from activity data 111 which may be input into the user device 400 and communicated to the compensation database 110. In further embodiments, an activity may involve providing evidence that a task was completed. For example an activity may comprise completing the task of visiting a patient at their house. Activity data 111 may be provided by information input into their user device 400 by the client 101B indicating that they are at or were at the patient's house, this may include GPS or location data provided by the user device 400.

Additionally, the compensation database 110 may also comprise completion metrics data 112. A completion metric may describe one or more inputs provided by a client 101B into their user device 400 or inputs provided by the user device 400 of the client 101B which may be used to denote that a client 101B has completed an activity from the activities data 111. The completion metric data 112 may also include one or more conditions and/or a number of conditions that must be satisfied in order for the activity to be deemed completed. Generally, an activity or task may comprise one or more conditions. A condition may comprise any requirement that can be satisfied with input recorded through or from a user device 400. Completion metrics and their conditions may be occupation specific. Client 101B input recorded through the user device 400 of the client 101B may be used to satisfy one or more conditions of a completion metric. Additionally, for completion metrics with two or more conditions, the completion metric may also define or provide a condition threshold. In some embodiments, a condition threshold may define or provide the minimum number of conditions that must be satisfied in order for the activity to be determined to be completed. In further embodiments, a condition threshold may define or provide which conditions must be satisfied in order for the activity to be determined to be completed. For example, an activity stored in the activities data 111 may be for a client 101B to participate in a continuing education class. The completion metric for this activity may include watching a video presentation and correctly answering one or more questions about material in the presentation. The completion metric data 112 may include conditions such as: was presentation displayed on the user device 400 of the client, yes or no; did the client 101B provide input into the user device 400 which correctly answered a first question, yes or no; and did the client 101B provide input into the user device 400 which correctly answered a second question, yes or no. The completion metric data 112 may also include which conditions and/or the number of conditions that must be satisfied in order for the activity to be deemed completed. In the above example, if the client 101B provides input into their user device 400 that satisfies two of the three conditions, answering at least one question correct and also had the entire presentation displayed on the user device 400, then the activity of watching a video presentation and correctly answering one or more questions about material in the presentation may be deemed completed and stored in the user information 113 for that client 101B.

The compensation database 110 may also include compensation level data 114. Compensation level data 114 may include data and information which describes how compensation is provided by an employer 101A to a client 101B. This data may include hourly wage rates, weekly wage rates, bi-weekly wage rates, per diem wage rates, and the like, salary rates, stock options, bonus pay rates, investment account pay rates, and/or any other information which may be used to describe how a client 101B receives compensation and how much compensation a client 101B may receive from an employer 101A if the client 101B is in an employment compensated position 115 maintained by the employer 101A.

The compensation database 110 may also include employment compensated position data 115. Generally, an employment compensated position is a relationship between a client 101B and an employer 101A wherein the client 101B may perform activities or tasks and the employer 101A may provide compensation to the client 101B in exchange for performance of those activities or tasks. For example, an employment compensated position may be a sales associate position and the employment compensated position data 115 may describe the position, such as who the employer is and the like. The employment compensated position data 115 may be associated with one or more compensation levels 114 for the sales associate position, one or more activities 111 to be completed by a client 101B that is a sales associate for that employer 101A and one or more completion metrics 112 for the activities 111.

The communication application 121 may comprise a computer program which may be executed by a computing device processor, such as a processor 302 (FIG. 2) and/or a processor 402 (FIG. 3), and which may be configured to govern electronic communication between severs 300 and user devices 400. Data from severs 300 and user devices 400 may be received by the communication application 121 which may then electronically communicate the data to the association application 122 and verification application 123. Likewise, data from the association application 122 and verification application 123 may be received by the communication application 121 which may then electronically communicate the data to servers 300 and user devices 400. In some embodiments, the communication application 121 may govern the electronic communication by initiating, maintaining, reestablishing, and terminating electronic communication between one or more user devices 400 and servers 300. In further embodiments, the communication application 121 may control the network interface 306 (FIG. 2) of the server 300 to send and receive data to and from one or more user devices 400 and other servers 300 through a network connection 104 (FIG. 1) over a network 105 (FIG. 1).

The association application 122 may comprise a computer program which may be executed by a computing device processor, such as a processor 302 (FIG. 2) and/or a processor 402 (FIG. 3), and which may be configured to store, retrieve, modify, create, and/or delete data and information, such as activity data 111, completion metric data 112, user information data 113, compensation level data 114, and employment compensated position data 115 into and from the compensation database 110. In some embodiments, the association application 122 receive data from the communication application 121 and/or verification application 123 and associate the data with activity data 111, completion metric data 112, user information data 113, compensation level data 114, and/or employment compensated position data 115 into the compensation database 110. In further embodiments, the association application 122 retrieve data from the compensation database 110, such as activity data 111, completion metric data 112, user information data 113, compensation level data 114, and/or employment compensated position data 115, and send or communicate the data to the communication application 121 and/or verification application 123.

The verification application 123 may comprise a computer program which may be executed by a computing device processor, such as a processor 302 (FIG. 2) and/or a processor 402 (FIG. 3), and which may be configured to compare data received from the communication application 121 to data received from the association application 122. In some embodiments, the verification application 123 may compare the client 101B input received by the communication application 121 through the user device 400 of the client 101B to a completion metric or completion metric data 112 retrieved by the association application 122 from the compensation database 110. The verification application 123 may be configured to determine if an activity has been completed by the client 101B using input from the user device 400 of the client 101B provided to the verification application 123 by the communication application 121 and data provided from the compensation database 110 by the association application 122. In some embodiments, the verification application 123 may determine an activity has been completed by the client 101B if the input from the user device 400 of the client 101B satisfies one or more conditions of a completion metric associated with the activity that the client 101B is attempting to complete.

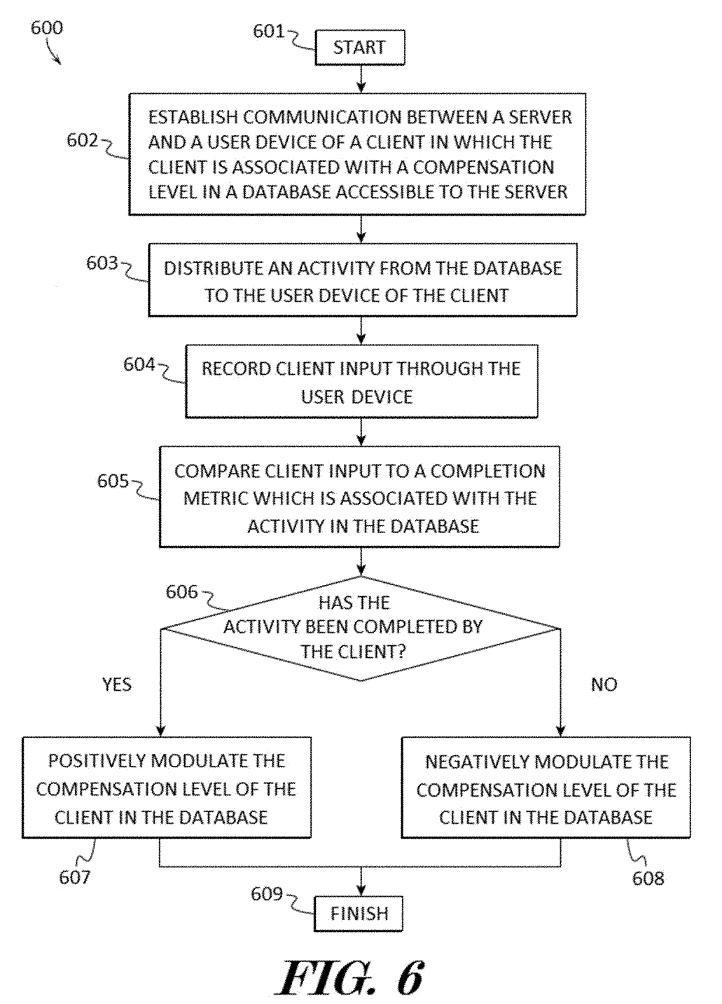

FIG. 6 shows a block diagram of an example of a computer-implemented method for modulating compensation based on activities completed with a user device (“the method”) 600 according to various embodiments described herein. In some embodiments, the method 600 may be used to enable the communication of information between the user devices 400 of one or more users 101 to modulate the compensation paid by an employer 101A to a client 101B based on one or more activities completed by the client 101B using their respective user device 400. One or more steps of the method 600 may be performed by a communication application 121, an association application 122, and/or a verification application 123 which may be executed by a computing device processor, such as a processor 302 (FIG. 2) and/or a processor 402 (FIG. 3).

In some embodiments, the method 600 may start 601 and communication between a server 300 and a user device 400 of a client 101B which is associated with a compensation level in a database accessible to the server 300 may be established and maintained by the communication application 121 in step 602. The system 100 may comprise user information data 113 (FIG. 5) describing the client 101B which may be associated with compensation level data 114 (FIG. 5) in the compensation database 110 by the association application 122, thereby associating the client 101B with a compensation level. For example, the user information data record of the client 101B may be associated with a compensation level of fifteen dollars an hour in the compensation database 110.

In step 603, an activity from the database may be distributed to the user device 400 of the client 101B. In some embodiments, an activity may be retrieved from activity data 111 (FIG. 5) of the compensation database 110 by the association application 122. The association application 122 may provide this data to the communication application 121 and the communication application 121 may communicate or distribute this data to the user device 400 of the client 101B. For example, the association application 122 may retrieve a training module type of activity which may include an instructional video and a number of multiple choice questions regarding the material covered in the instructional video.

Continuing to step 604, client 101B input may be recorded through the user device 400 of the client 101B. In some embodiments, input may comprise data received through one or more (I/O) interfaces 404, such as a touch screen, keyboard, mouse or track ball, microphone, camera, and the like, of the user device 400 of the client 101B. In further embodiments, the client 101B input may comprise answers and data entered into the user device 400 by the client 101B, location data recorded by a location sensor or location application, such as global positioning service (GPS) data and network location data, of the user device 400 of the client 101B, data recorded about what is visually and/or audibly output by an (I/O) interface 404, such as a display screen and/or speaker, of the user device 400 of the client 101B, and/or any other data which may be recorded through an (I/O) interface 404 of the user device 400 of the client 101B. Once the client 101B input is recorded, it may be communicated by the communication application 121 to the association application 122. The association application 122 may store this input data in the compensation database 100 optionally as user information data 113. Continuing the example from above, the instructional video may be displayed on a touch screen display screen of the user device 400 and the client 101B may use the touch screen display screen to enter their answers to the number of multiple choice questions regarding the material covered in the instructional video. Allowing the entire video to play on the touch screen display screen and receiving the answers to the questions may both be recorded as client 101B input through the user device 400.

In step 605, the client input 101B may be compared to a completion metric which is associated with the activity in the database. In some embodiments, the verification application 123 may compare the client 101B input received by the communication application 121 through the user device 400 of the client 101B to a completion metric or completion metric data 112 associated with the activity which may be retrieved by the association application 122 from the compensation database 110. A completion metric may describe one or more inputs provided by a client 101B into their user device 400 or inputs provided by the user device 400 of the client 101B which may be used to denote that a client 101B has completed an activity from the activities data 111. The completion metric data 112 may also include one or more conditions and/or a number of conditions that must be satisfied in order for the activity to be deemed completed. These conditions may be met by client 101B input that may be entered into the user device 400 of the client 101B. Continuing the example from above, the training module type of activity may be associated with a completion metric with conditions including whether or not the instructional video was displayed in its entirety and a minimum of 80% correct of the multiple choice questions regarding the material covered in the instructional video.

At decision block 606, it may be determined, via a computing device processor running a verification application 123, if the activity has been completed by the client 101B. In some embodiments, the verification application 123 may determine which, if any, of the recorded client input matches or satisfies the conditions of a completion metric for the activity.

If the recorded client input matches or satisfies the minimum number of and/or which conditions must be satisfied in order for the activity to be determined to be completed found in a condition threshold, then the verification application 123 may determine that the activity has been completed. Next, the method 600 may proceed to step 607 and the compensation level of the client may be positively modulated in the compensation database 110. Continuing the above example, if the recorded client input comprises data indicating that the instructional video was displayed in its entirety and 80% or more of the multiple choice questions regarding the material covered in the instructional video were answered correctly, then the verification application 123 may determine that the activity was completed. Data describing that the activity was completed may be provided to the association application 122, and the association application 122 may positively modulate the compensation level data 114 for the client 101B in the compensation database 110. In some embodiments, positive modulation may correspond to an increase in the amount and/or frequency of compensation that the client 101B may receive from their employer 101A. Continuing the above example, the compensation level of the client 101B may be positively modulated by increasing their pay rate from fifteen dollars an hour to fifteen dollars and twenty five cents an hour. In further embodiments, positive modulation may correspond to increasing the compensation level of the client from zero to a positive number, such as to enable the client 101B to receive compensation up to and including establishing a client 101B employer 101A relationship.

If the recorded client input does not match or satisfy the minimum number of and/or which conditions must be satisfied in order for the activity to be determined to be completed found in a condition threshold, then the verification application 123 may determine that the activity has not been completed. Next, the method 600 may proceed to step 608 and the compensation level of the client may be negatively modulated in the compensation database 110. Continuing the above example, if the recorded client input comprises data indicating that the instructional video was not displayed in its entirety and less than 80% of the multiple choice questions regarding the material covered in the instructional video were answered correctly, then the verification application 123 may determine that the activity was not completed. Data describing that the activity was not completed may be provided to the association application 122, and the association application 122 may negatively modulate the compensation level data 114 for the client 101B in the compensation database 110. In some embodiments, negative modulation may correspond to a decrease in the amount and/or frequency of compensation that the client 101B may receive from their employer 101A. Continuing the above example, the compensation level of the client 101B may be negatively modulated by decreasing their pay rate from fifteen dollars an hour to fourteen dollars and seventy five cents an hour. In further embodiments, negative modulation may correspond to decreasing the compensation level of the client from a positive number to zero, such as to prevent the client 101B from receiving compensation up to and including terminating the client 101B employer 101A relationship.

Upon completion of steps 607 or 608, the method 600 may finish 609.

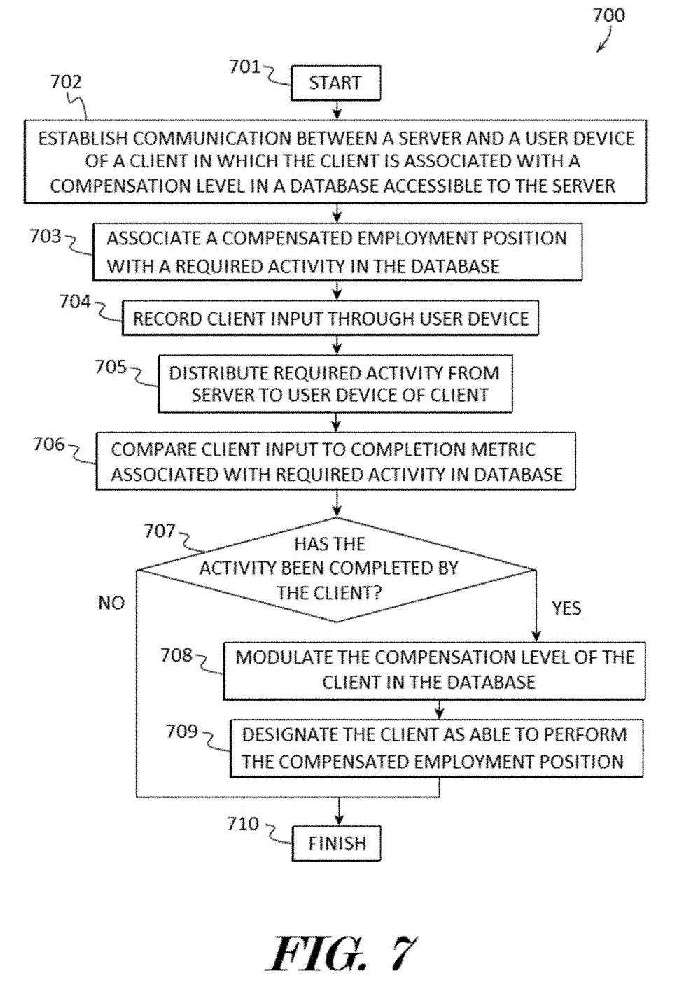

FIG. 7 depicts a block diagram of another example of a computer-implemented method for modulating compensation based on activities completed with a user device (“the method”) 700 according to various embodiments described herein. In some embodiments, the method 700 may enable the communication of information between the user devices 400 of one or more users 101 to enable a client 101B to receive compensation from an employer 101A upon completion of one or more activities by the client 101B using their respective user device 400. One or more steps of the method 700 may be performed by a communication application 121, an association application 122, and/or a verification application 123 which may be executed by a computing device processor, such as a processor 302 (FIG. 2) and/or a processor 402 (FIG. 3).

In some embodiments, the method 700 may start 701 and communication between a server 300 and a user device 400 of a client 101B which is associated with a compensation level in a database accessible to the server 300 may be established and maintained by the communication application 121 in step 702. The system 100 may comprise user information data 113 (FIG. 5) describing the client 101B which may be associated with compensation level data 114 (FIG. 5) in the compensation database 110 by the association application 122, thereby associating the client 101B with a compensation level. For example, the user information data record of the client 101B may be associated with a compensation level of 2000 dollars every two weeks in the compensation database 110.

In step 703 a compensated employment position may be associated with a required activity in the database. In some embodiments, information describing a compensated employment position may be stored in employment compensated position data 115 of the compensation database 110 by the association application 122. This information may include data describing the name of an occupation, typical duties of the occupation, requirements for commencing and/or continuing the practice of an occupation, an employer 101A providing the occupation, and any other information which may describe an occupation. The employment compensated position data 115 may be associated with activity data 111 in the compensation database 110 by the association application 122. The activity data may describe one or more activities and the employment compensation position data may describe which activities may be optional and which activities may be required (required activities) to be completed for a client 101B to participate or practice an employment compensated position or occupation. Each activity may comprise one or more tasks which may be completed by the client 101B on their user device 400. For example, the employment compensated position of home healthcare aide may be associated with the required activity of Cardiopulmonary resuscitation (CPR) training, and the CPR training activity may include the tasks of a CPR training video and a set of ten questions regarding the CPR training video.

Next in step 704, the required activity may be distributed from the server 300 to the user device 400 of the client 101B. In some embodiments, the associating application 122 may retrieve the required activity, including the tasks of the activity, from activity data 111 and provide this data to the communication application 121. The communication application may then distribute this data from the server 300 to the user device 400 of the client 101B, using user device 400 address or identity information which may be in the user information data 113 of the client 101B. Continuing the example from above, the CPR training activity, including the tasks of a CPR training video and a set of ten questions regarding the CPR training video, may be distributed or communicated to the user device 400 of the client 101B.

Next, the client 101B input may be recorded through the user device 400 of the client 101B in step 705. In some embodiments, input may comprise data received through one or more (I/O) interfaces 404, such as a touch screen, keyboard, mouse or track ball, microphone, camera, and the like, of the user device 400 of the client 101B. In further embodiments, the client 101B input may comprise answers and data entered into the user device 400 by the client 101B, location data recorded by a location sensor or location application, such as global positioning service (GPS) data and network location data, of the user device 400 of the client 101B, data recorded about what is visually and/or audibly output by an (I/O) interface 404, such as a display screen and/or speaker, of the user device 400 of the client 101B, and/or any other data which may be recorded through an (I/O) interface 404 of the user device 400 of the client 101B. Once the client 101B input is recorded, it may be communicated by the communication application 121 to the association application 122. The association application 122 may store this input data in the compensation database 100 optionally as user information data 113. Continuing the example from above, the CPR training video may be displayed on a touch screen display screen of the user device 400 and the client 101B may use the touch screen display screen to enter their answers to the set of ten questions regarding the CPR training video. Allowing the entire video to play on the touch screen display screen and receiving the answers to the questions may both be recorded as client 101B input through the user device 400.

In step 706, the client input 101B may be compared to a completion metric which is associated with the required activity in the database. In some embodiments, the verification application 123 may compare the client 101B input received by the communication application 121 through the user device 400 of the client 101B to a completion metric or completion metric data 112 associated with the required activity which may be retrieved by the association application 122 from the compensation database 110. A completion metric may describe one or more inputs provided by a client 101B into their user device 400 or inputs provided by the user device 400 of the client 101B which may be used to denote that a client 101B has completed an activity from the activities data 111. The completion metric data 112 may also include one or more conditions and/or a number of conditions that must be satisfied in order for the activity to be deemed completed. These conditions may be met by client 101B input that may be entered into the user device 400 of the client 101B. Continuing the example from above, the CPR training activity may be associated with a completion metric with conditions including whether or not the CPR training video was displayed in its entirety and whether all questions regarding the CPR training video were correctly answered on the user device 400 of the client 101B.

At decision block 707, it may be determined, via a computing device processor running a verification application 123, if the required activity has been completed by the client 101B. In some embodiments, the verification application 123 may determine which, if any, of the recorded client input matches or satisfies the conditions of a completion metric for the activity.

If the recorded client input matches or satisfies the minimum number of and/or which conditions must be satisfied in order for the activity to be determined to be completed found in a condition threshold, then the verification application 123 may determine that the activity has been completed and the compensation level of the client may be modulated, such as by being positively or negatively modulated, in the compensation database 110. Continuing the above example, if the recorded client input comprises data indicating that the instructional CPR training video was displayed in its entirety and all questions regarding the CPR training video were correctly answered, then the verification application 123 may determine that the required activity was completed. Data describing that the required activity was completed may be provided to the association application 122, and the association application 122 may positively modulate the compensation level data 114 for the client 101B in the compensation database 110. In some embodiments, the compensation level may be positively modulated which may correspond to an increase in the amount and/or frequency of compensation that the client 101B may receive from their employer 101A. Continuing the above example, the compensation level of the client 101B may be positively modulated by increasing their pay rate from 2000 dollars every two weeks to 2100 dollars every two weeks. In further embodiments, positive modulation may correspond to increasing the compensation level of the client from zero to a positive number, such as to enable the client 101B to receive compensation up to and including establishing a client 101B employer 101A relationship. For example, the compensation level of the client 101B may be positively modulated by increasing their pay rate from zero dollars every two weeks to 1300 dollars every two weeks.

If the recorded client input does not match or satisfy the minimum number of and/or which conditions must be satisfied in order for the required activity to be determined to be completed found in a condition threshold, then the verification application 123 may determine that the activity has not been completed and the compensation level of the client may be negatively modulated in the compensation database 110 by the association application 122. Continuing the above example, if the recorded client input does not comprise data indicating that the instructional CPR training video was displayed in its entirety and all questions regarding the CPR training video were not correctly answered, then the verification application 123 may determine that the required activity was not completed. Data describing that the activity was not completed may be provided to the association application 122, and the association application 122 may negatively modulate the compensation level data 114 for the client 101B in the compensation database 110. In some embodiments, negative modulation may correspond to a decrease in the amount and/or frequency of compensation that the client 101B may receive from their employer 101A. Continuing the first above example, the compensation level of the client 101B may be negatively modulated by decreasing their pay rate from 2000 dollars every two weeks to 1900 dollars every two weeks. In further embodiments, negative modulation may correspond to decreasing the compensation level of the client from a positive number to zero, such as to prevent the client 101B from receiving compensation up to and including terminating the client 101B employer 101A relationship. For example, the compensation level of the client 101B may be negatively modulated by decreasing their pay rate from 1300 dollars every two weeks to zero dollars every two weeks. Optionally, if the client 101B has not completed the required activity and the compensation level of the client 101B has been modulated, optionally negatively modulated, in step 708, the method 700 may end and proceed to finish 610.

If the client 101B has completed the required activity and the compensation level of the client 101B has been modulated, optionally positively modulated, in step 708, the method 700 may proceed to step 709 and the client 101B may be designated as able to perform the compensated employment position. In some embodiments, data describing that the required activity was completed may be provided to the association application 122, and the association application 122 may designate that the client 101B is able to perform the compensated employment position in the user information data 113 for the client 101B in the compensation database 110. In further embodiments, once the client 101B is designated as being able to perform the compensated employment position, the client 101B may then be allowed to perform the duties of the compensated employment position or occupation. In still further embodiments, once the client 101B is designated as being able to perform the compensated employment position, the client 101B may then be allowed to perform one or more specific duties, preferably corresponding to the completed activity, of the compensated employment position. In still further embodiments, once the client 101B is designated as being able to perform the compensated employment position, the client 101B may then be allowed to perform one or more specific duties, preferably corresponding to the completed activity, of the compensated employment position and to be ranked or scheduled according to how many completed activities the client 101B has accomplished through the system 100. After step 709, the method 700 may finish 710.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD) or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or wifi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a user device or client device such as a personal digital assistant (PDA), laptop computer, tablet computer, smartphone, or cellular telephone. The LAN communications network and the other communications networks such as cellular wireless and wifi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A computer-implemented method for modulating compensation based on activities completed with a user device, the method comprising:
establishing communication between a server and a user device of a client, wherein the client is associated with a compensation level in a database accessible to the server;
distributing an activity from the database to the user device of the client;
recording client input through the user device;
comparing, via a computing device processor, the client input to a completion metric which is associated with the activity in the database;
determining, via a computing device processor, if the activity has been completed by the client; and
modulating the compensation level of the client in the database once the activity has been completed.

2. The method of claim 1, wherein the completion metric comprises a condition, and wherein client input is used to satisfy the condition.

3. The method of claim 1, wherein the completion metric comprises more than one condition, and wherein the completion metric comprises a condition threshold which describes a minimum number of conditions that must be satisfied for the activity to be determined to be complete.

4. The method of claim 1, wherein the activity comprises the display of a video on a display screen of the user device.

5. The method of claim 1, wherein the activity comprises the outputting an audio file through a speaker of the user device.

6. The method of claim 1, wherein the activity comprises displaying one or more questions on a display screen of the user device.

7. The method of claim 1, wherein the client input is recorded through a touch screen of the user device.

8. The method of claim 1, wherein the compensation level of the client is positively modulated in the database once the activity has been completed.

9. The method of claim 1, wherein the compensation level of the client is negatively modulated in the database if the activity is not completed.

10. A computer-implemented method for modulating compensation based on activities completed with a user device, the method comprising:
establishing communication between a server and a user device of a client, wherein the client is associated with a compensation level in a database;
associating a compensated employment position with a required activity in the database;
distributing the required activity from the server to the user device of the client;
recording client input through the user device;
comparing, via a computing device processor, the client input to a completion metric which is associated with the required activity in the database;
determining, via a computing device processor, if the required activity has been completed by the client;
modulating the compensation level of the client in the database once the required activity has been completed; and
designating the client as able to perform the compensated employment position once the required activity has been completed.

11. The method of claim 10, wherein the completion metric comprises a condition, and wherein client input is used to satisfy the condition.

12. The method of claim 10, wherein the completion metric comprises more than one condition, and wherein the completion metric comprises a condition threshold which describes a minimum number of conditions that must be satisfied for the activity to be determined to be complete.

13. The method of claim 10, wherein the activity comprises the display of a video on a display screen of the user device.

14. The method of claim 10, wherein the activity comprises the outputting an audio file through a speaker of the user device.

15. The method of claim 10, wherein the activity comprises displaying one or more questions on a display screen of the user device.

16. The method of claim 10, wherein the client input is recorded through a touch screen of the user device.

17. The method of claim 10, wherein the compensation level of the client is positively modulated in the database once the activity has been completed.

18. The method of claim 17, wherein the compensation level of the client is positively modulated in the database to a positive number above zero.

19. The method of claim 10, wherein the compensation level of the client is negatively modulated in the database if the activity is not completed.

20. The method of claim 19, wherein the compensation level of the client is negatively modulated in the database to zero.
